(19) United States
(12) Patent Application Publication
(10) Pub. No.: US 2007/0094352 A1
(43) Pub. Date: Apr. 26, 2007

(54) Method and apparatus for displaying web page

(75) Inventors: Sang-hoon Choi, Seoul (KR); Hyun-sik Yoon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/583,864

(22) Filed: Oct. 20, 2006

(30) Foreign Application Priority Data
Oct. 20, 2005 (KR) 10-2005-0099336

(51) Int. Cl. G06F 15/16

(52) U.S. Cl. 709/218

(57) ABSTRACT

A method and an apparatus for easily displaying a web page on a consumer electric device are provided. When a request for exporting user context information of a web page through a user interface of the web page is received, the user context information is exported to a device capable of displaying the web page according to the request.

### CROSS-REFERENCE TO RELATED PATENT APPLICATION

This application claims the benefit of Korean Patent Application No. 10-2005-0099336, filed on Oct. 20, 2005, in the Korean Intellectual Property Office, the disclosure of which is incorporated herein in its entirety by reference.

### BACKGROUND OF THE INVENTION

1. Field of the Invention

Methods and apparatuses consistent with the present invention relate to a method and apparatus for displaying a web page using a web service, and more particularly, to a method and apparatus for easily displaying a web page on a consumer electric (CE) device.

2. Description of the Related Art

Recently, as home networks have become very popular, CE devices such as digital televisions and personal computers have a home network connection function. Thus, a web service can be provided using the CE devices.

FIG. 1 illustrates a related art home network environment.

Referring to FIG. 1, the related art home network environment includes a web server 11, a personal computer 12, and a digital television 13.

When a user wants to receive a web service from the web server 11 using the personal computer 12, the user must input the uniform resource locator (URL) of a web page providing the web service using input units such as a keyboard and a mouse of the personal computer 12. Further, if the web service requires user authentication, the user must input a user ID and a password on the web page.

Meanwhile, when the user wants to receive the web service from the web server 11 using the digital television 13, the user must input the URL of the web page providing the web service using a simple input unit such as a remote controller of the digital television 13. In addition, the user may input a user identification ID and a password on the web page, if necessary.

However, since the remote controller is designed for simple input operations such as channel change, screen adjustment, and volume adjustment of the digital television 13, it is inconvenient for the user to input text information such as the URL of the web page using the remote controller. In order to address this problem, research for simplifying the web service has been conventionally made, but cannot be applied to a general web service.

### SUMMARY OF THE INVENTION

The present invention provides a method and apparatus which allows a user of a CE device such as a digital television to use a web service using a simple input unit such as a remote controller, without inputting the uniform resource locator and user context information of a web page.

The present invention also provides a computer-readable medium having embodied thereon a computer program for performing the above-mentioned method.

According to an aspect of the present invention, there is provided a method of providing user context information, including receiving a request for exporting the user context information of a web page through a user interface of the web page; and exporting the user context information to a device which capable of displaying the web page according to the received request.

According to another aspect of the present invention, there is provided an apparatus for providing user context information, including a web browser which receives a request for exporting the user context information of a web page through a user interface of the web page; and an export unit which exports the user context information to a device capable of displaying the web page according to the received request.

According to another aspect of the present invention, there is provided a computer-readable medium having embodied thereon a computer program for performing the method of providing the user context information.

According to another aspect of the present invention, there is provided a method of displaying a web page, including importing user context information of the web page from a device for displaying the web page; and displaying the web page based on the imported user context information.

According to another aspect of the present invention, there is provided an apparatus for displaying a web page, including an import unit which imports user context information of the web page from a device for displaying the web page; and a web browser which displays the web page based on the user context information imported by the import unit.

According to another aspect of the present invention, there is provided a computer-readable medium having embodied thereon a computer program for performing the method of displaying a web page.

According to another aspect of the present invention, there is provided a method of providing user context information based on universal plug and play (UPnP), including receiving a request for exporting the user context information of a web page through a user interface of the web page; and exporting the user context information to a media server which provides a content directory service based on UPnP to a device capable of displaying the web page, according to the received request.

According to another aspect of the present invention, there is provided an apparatus for providing user context information, including a web browser which receives a request for exporting the user context information of a web page through a user interface of the web page; and a UPnP control point (CP) stack which exports the user context information to a media server which provides a content directory service based on UPnP to a device capable of displaying the web page, according to the received request.

According to another aspect of the present invention, there is provided a computer-readable medium having embodied thereon a computer program for performing the method of providing user context information based on UPnP.

According to another aspect of the present invention, there is provided a method of displaying a web page based on UpnP, including importing user context information of the web page from a media server which provides a content directory service based on UPnP to a device capable of displaying the web page; and displaying the web page based on the imported user context information.

According to another aspect of the present invention, there is provided an apparatus for displaying a web page based on UpnP, including a UPnP CP stack which imports user context information of the web page from a media server which provides a content directory service based on UPnP to a device capable of displaying the web page; and a web browser which displays the web page based on the user context information imported by the UPnP CP stack.

According to another aspect of the present invention, there is provided a computer-readable medium having embodied thereon a computer program for performing the method of displaying a web page based on UPnP.

### BRIEF DESCRIPTION OF THE DRAWINGS

The above and other aspects of the present invention will become more apparent by describing in detail exemplary embodiments thereof with reference to the attached drawings in which:

FIG. 1 illustrates a related art home network environment;

FIG. 2 illustrates a home network environment according to an exemplary embodiment of the present invention;

FIG. 3 illustrates configurations of a personal computer (PC) and a digital television (DTV);

FIG. 4 illustrates a portion of a document for a web page displayed by a web browser according to an exemplary embodiment of the present invention;

FIG. 5 illustrates a pseudo code document illustrating a function of an export unit according to an exemplary embodiment of the present invention;

FIG. 6 illustrates a format of user context information according to an exemplary embodiment of the present invention;

FIG. 7 illustrates a user context information according to an exemplary embodiment of the present invention;

FIG. 8 illustrates a universal plug and play (UPnP)-based home network environment according to an exemplary embodiment of the present invention;

FIG. 9 illustrates configurations of a personal computer (PC), a media server, and a digital television (DTV) according to an exemplary embodiment of the present invention;

FIGS. 10 and 11 illustrate a digital item declaration (DIDL) lite character string according to an exemplary embodiment of the present invention;

FIG. 12 illustrates a web page displayed on the personal computer of FIG. 3 or FIG. 9 according to an exemplary embodiment of the present invention;

FIGS. 13 to 15 illustrate a web page displayed on the digital television of FIG. 3 or FIG. 9 according to an exemplary embodiment of the present invention;

FIG. 16 is a flowchart illustrating a process of transmitting/receiving user context information according to an exemplary embodiment of the present invention; and

FIG. 17 is a flowchart illustrating a process of transmitting/receiving user context information based on UPnP according to an exemplary embodiment of the present invention.

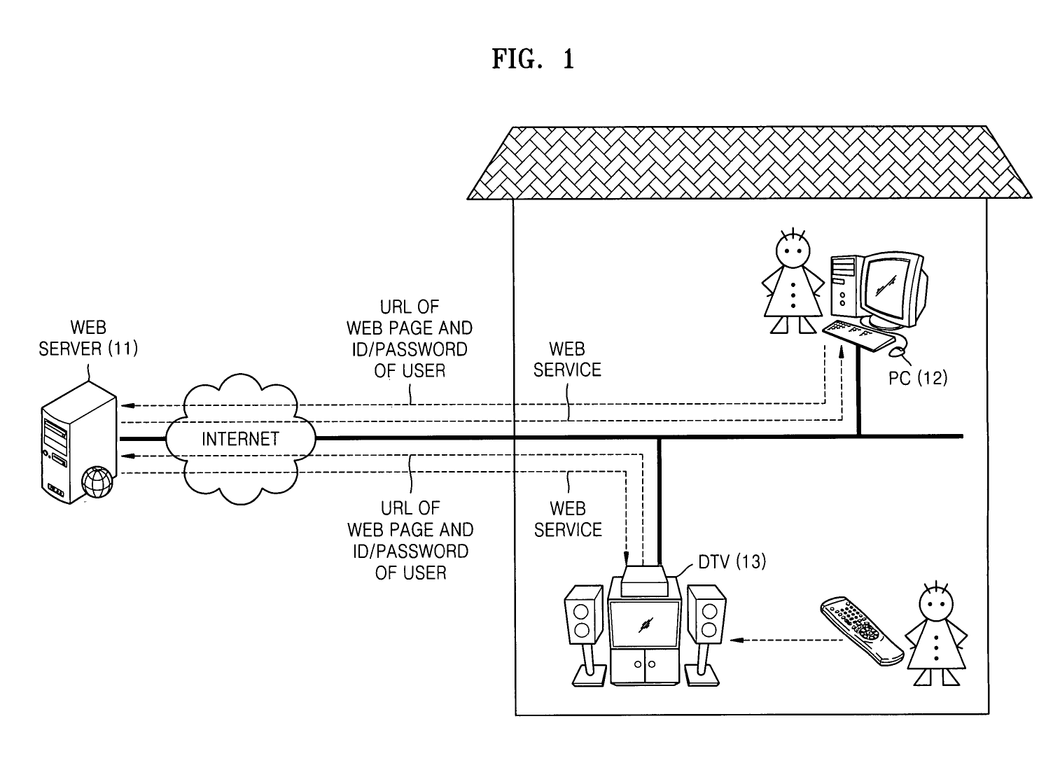

### DETAILED DESCRIPTION OF EXEMPLARY EMBODIMENTS OF THE INVENTION

Hereinafter, exemplary embodiments of the present invention will be described in detail with reference to the accompanying drawings.

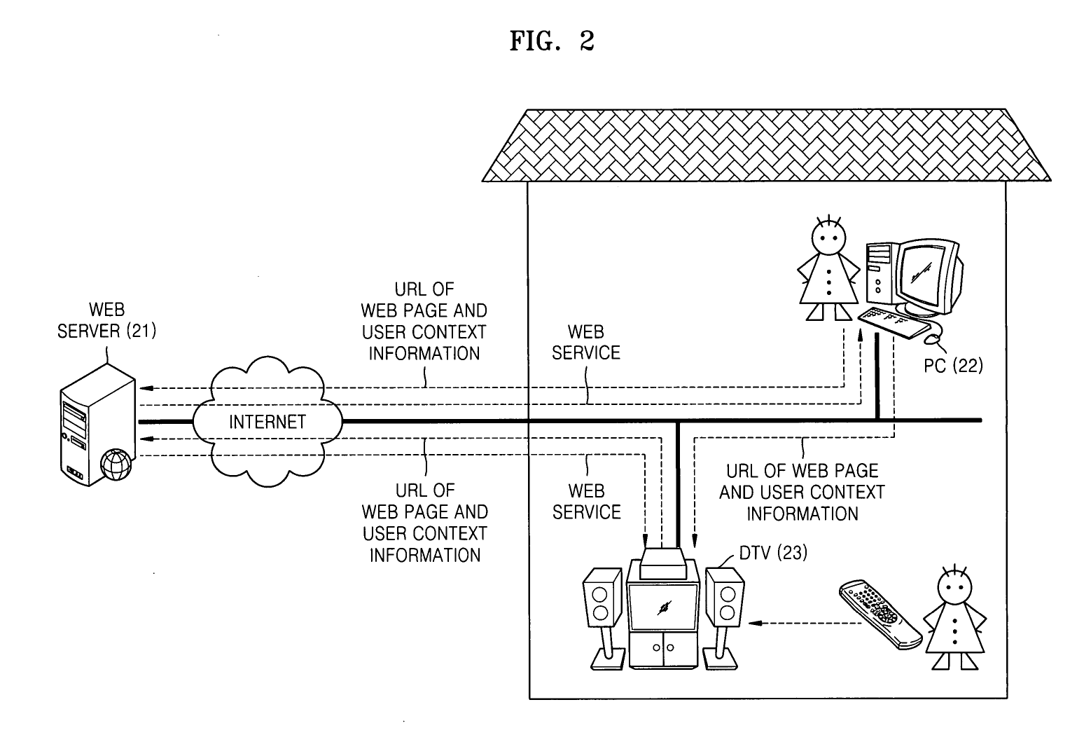

FIG. 2 illustrates a home network environment according to an exemplary embodiment of the present invention.

Referring to FIG. 2, the home network environment according to the present exemplary embodiment includes a web server 21, a personal computer 22, and a digital television 23.

When a user wants to receive a web service from the web server 21 using the personal computer 22, the user inputs a uniform resource locator of a web page for providing the web service of the web server 21, and a user ID and a password of the web page using input units such as a keyboard and a mouse of the personal computer 22 to generate user context information. In other words, the user context information represents context generated by the user's action on the web page and each web page has its user context information.

According to the present exemplary embodiment, the user exports the user context information stored in the personal computer 22 through a simple key operation to the digital television 23. Thus, in order to receive the web service from the web server 21 using the digital television 23, the user need not input the uniform resource locator and the user context information of the web page using a simple input unit such as a remote controller.

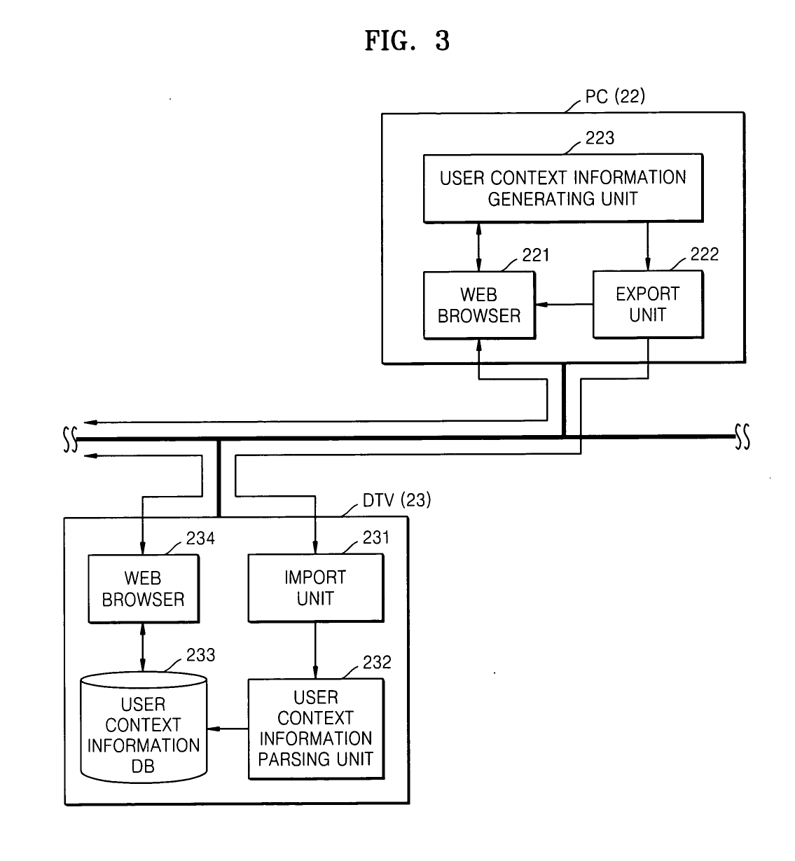

FIG. 3 illustrates configurations of a personal computer (PC) 22 and a digital television (DTV) 23.

Referring to FIG. 3, the personal computer 22 according to the present exemplary embodiment includes a web browser 221, an export unit 222, and a user context information generating unit 223.

The web browser 221 displays a web page and receives a request for exporting the user context information of the web page through a user interface of the web page. In particular, the web browser 221 displays a link representing the export unit 222 installed in a plug-in form in the web page, and receives the request for exporting the user context information of the web page when a user clicks the link.

In addition, when the link representing the export unit 222 is clicked, the web browser 221 recognizes and executes the export unit 222 to process the request. In other words, when the web browser 221 receives the request for exporting the user context information of the web page through the user interface of the web page, the web browser 221 displays a list including at least one device searched by the export unit 222.

Furthermore, the web browser 221 receives the request for exporting the user context information of the web page to any one device in the list through the user interface of the web page. In other words, when the user selects any one device from the list displayed on the web page, the web browser 221 receives the selected device.

When the user context information is exported by the export unit 222, the web browser 221 displays on the web page that the user context information of the web page is exported.

In the present exemplary embodiment, the user context information represents context generated by the user's action on the web page and each web page has its user context information. The user context information may be, for example, a user ID and a password input by the user when the web page requires user authentication.

When the request for exporting the user context information of the web page through the web browser 221 is received, the export unit 222 searches for at least one device which can display the web page displayed by the web browser 221 in a home network having the personal computer 22 and outputs the searched result to the web browser 221.

Furthermore, when any one device, for example, the digital television 23, is selected through the web browser 221, the export unit 222 exports the user context information generated by the user context information generating unit 223 to the digital television 23. Since the personal computer 22 and the digital television 23 have different screen sizes and resolutions, the digital television 23 cannot display the same web page using web page data displayed on the personal computer 22. In other words, the URL of the web page varies depending on the kind of the displaying device. Accordingly, the export unit 222 exports the user context information and the URL of the web page for the digital television 23.

Specifically, the export unit 222 is installed in the web page displayed by the web browser 221 in a plug-in form. According to a hypertext markup language of the web page, a plug-in program can be freely inserted into the web page. The web browser 221 automatically recognizes and executes the plug-in program inserted into the web page.

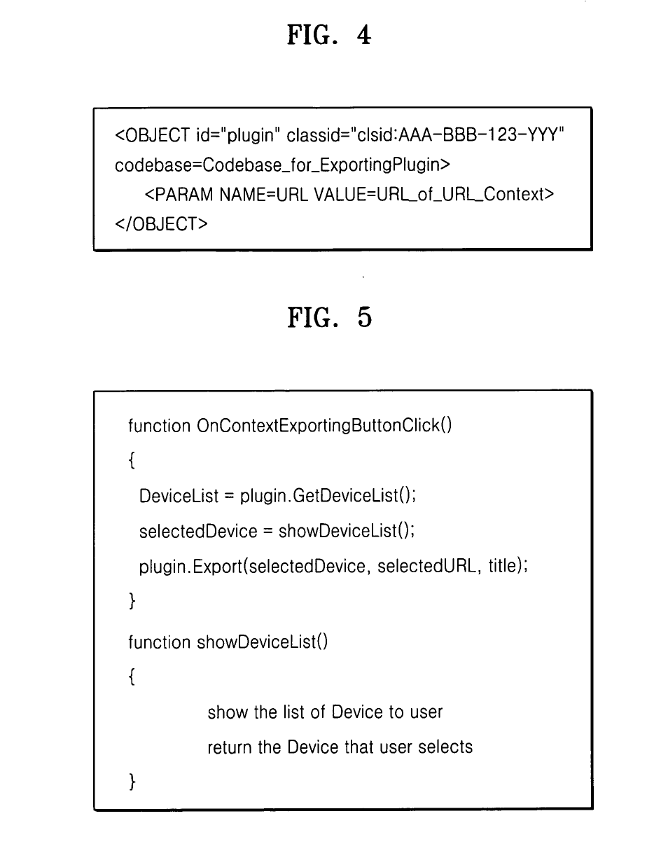

FIG. 4 illustrates a portion of a document for the web page displayed by the web browser 221 according to an exemplary embodiment of the present invention, which defines a plug-in object corresponding to the export unit 222 using the HTML. In particular, the URL of the web page for the device which can display the web page is written in VALUE=URL_of_URL_Context. In other words, if the device which can display the web page is the digital television 23, the URL of the web page for the digital television 23 is written in VALUE=URL_of_URL_Context.

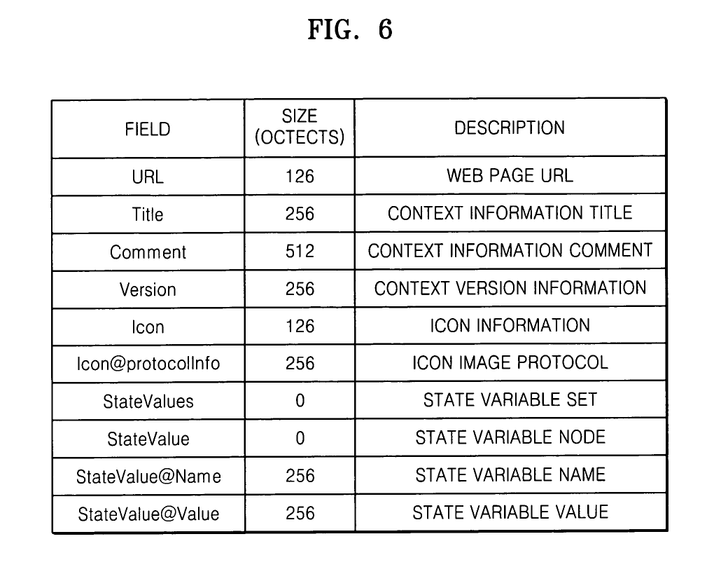

FIG. 5 illustrates a pseudo code document illustrating a function of the export unit 222 according to an exemplary embodiment of the present invention, which includes a function of outputting the device searching result of the export unit 222 and a function of exporting the user context information in pseudo code. In particular, DeviceList=plugin.GetDeviceList( ) represents that the devices are searched in a plug-in form. In addition, selectedDevice=showDeviceList( ) represents that the device searching result is output to the web browser 221 and the request for exporting the user context information to any one device is received from the web browser 221. Furthermore, plugin.Export(selectedDevice, selectedURL, title) represents that the user context information is exported to any one device in the plug-in form.

The user context information generating unit 223 extracts information generated by the user's action on the web page from the web page displayed by the web browser 221 and generates the user context information in a predefined format to be recognized by the device according to the present exemplary embodiment.

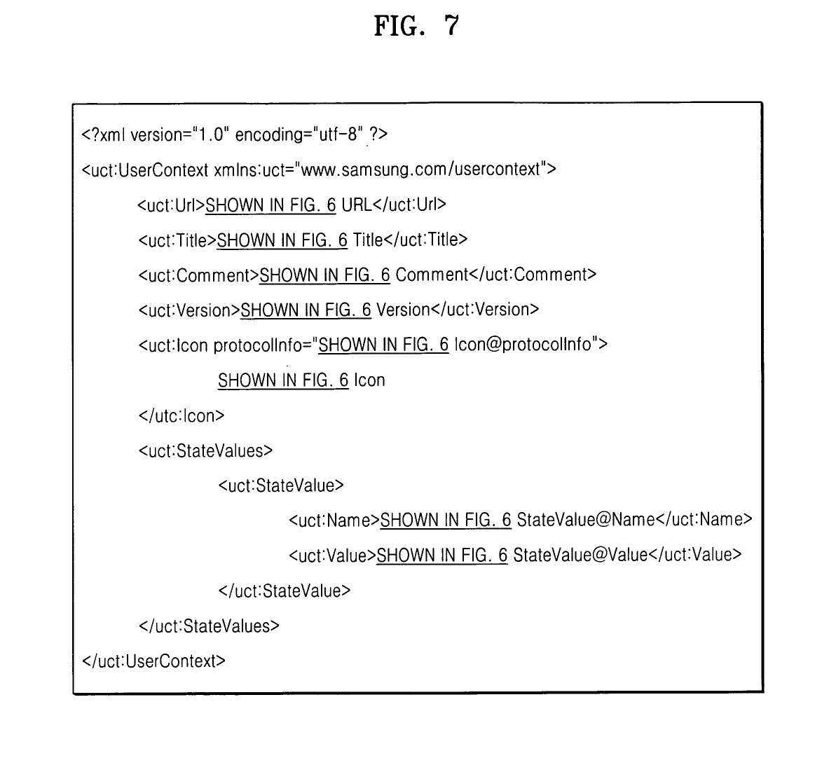

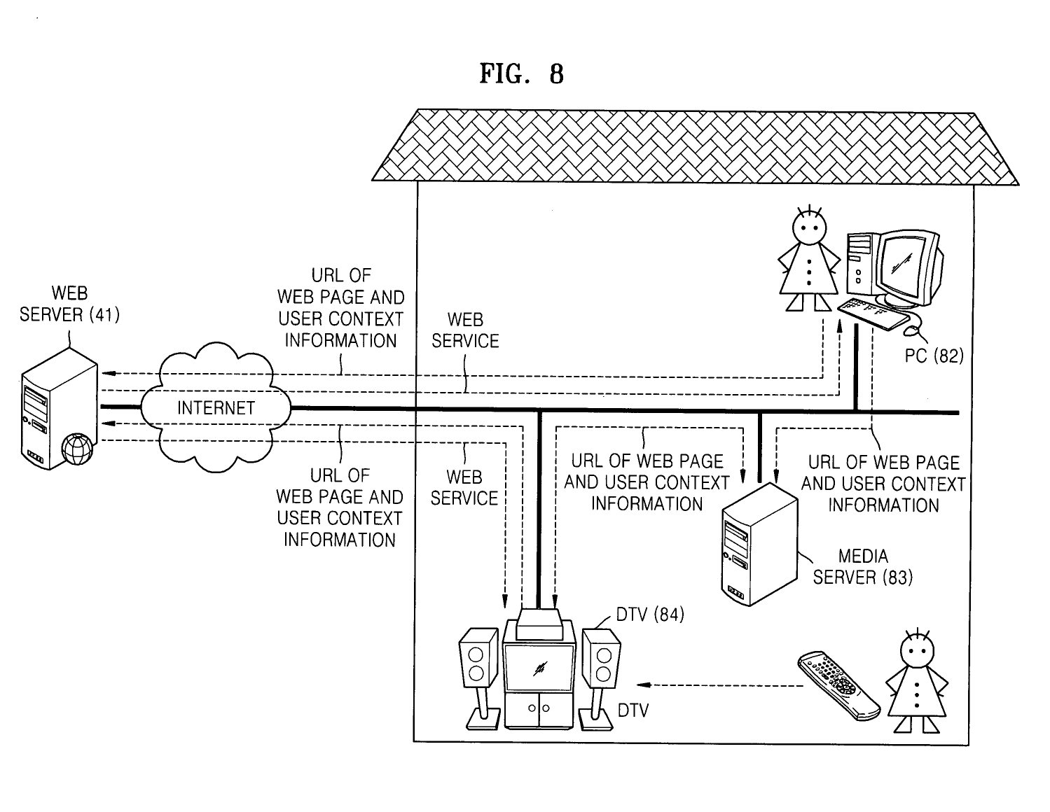

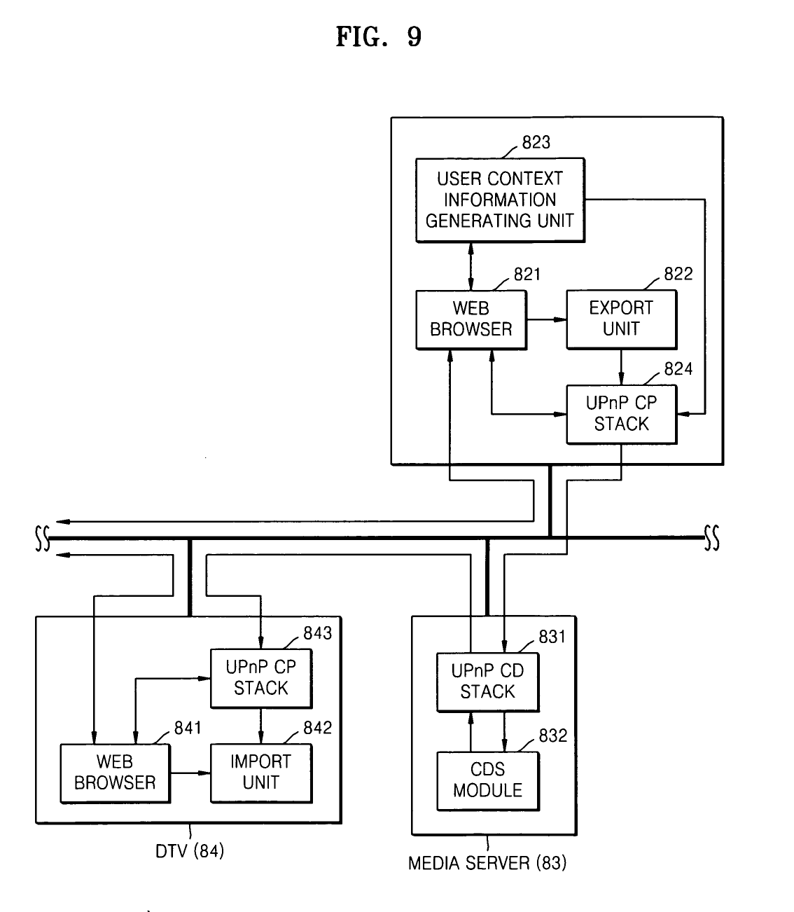

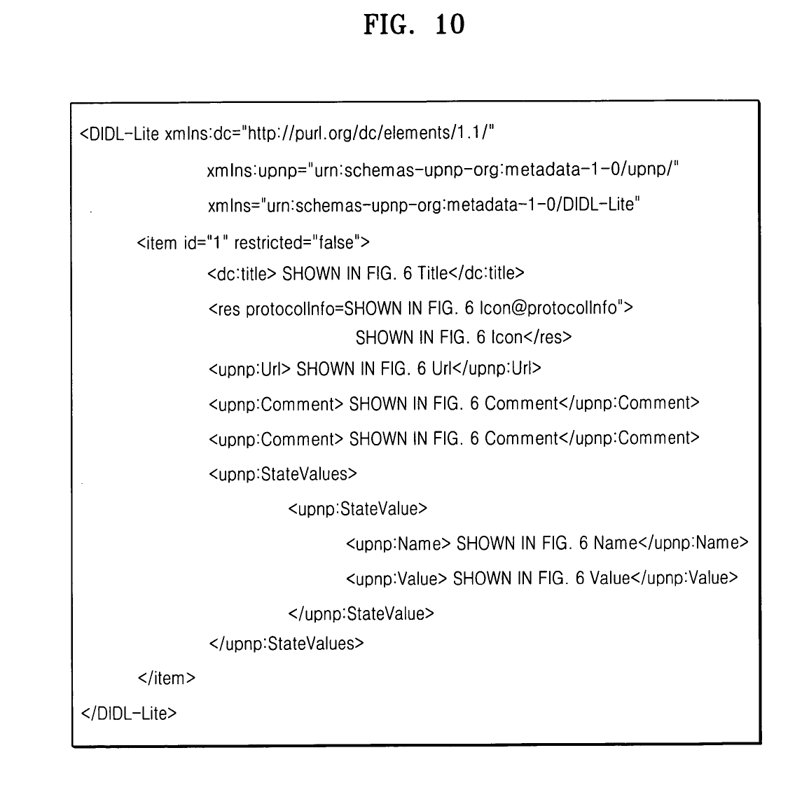

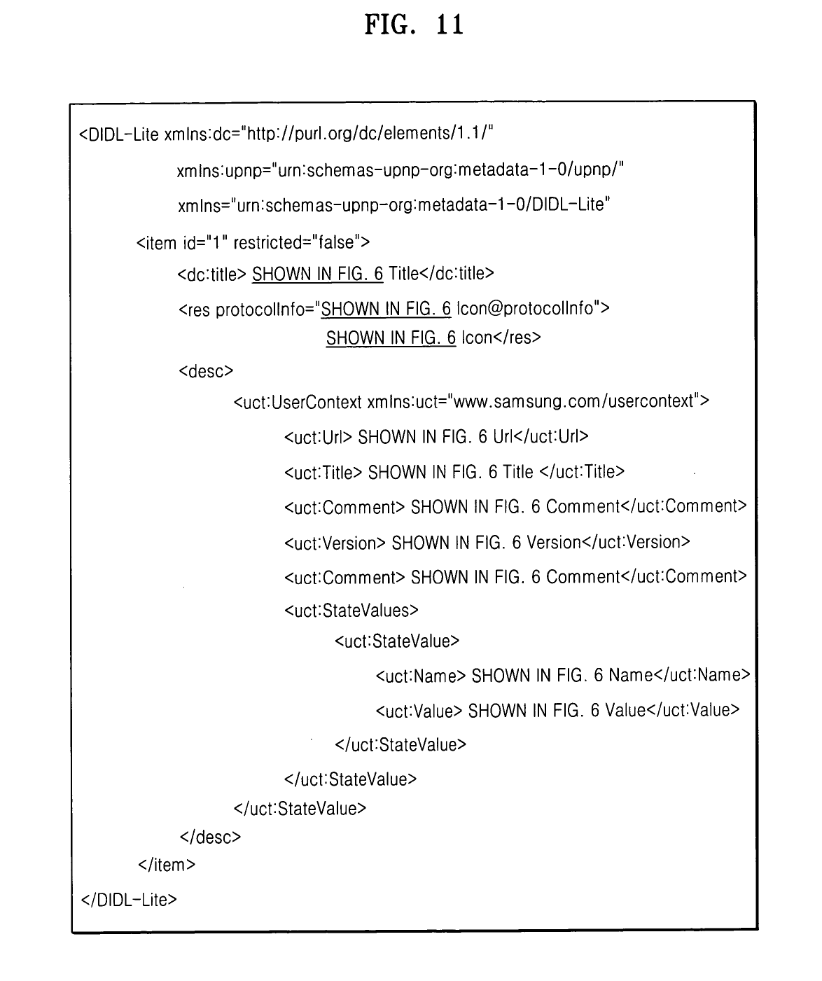

FIG. 6 illustrates a format of the user context information according to an exemplary embodiment of the present invention. URL field represents the URL of the web page. In addition, Title field, Comment field, and Version field represent the user context information. Furthermore, Icon field and Icon@protocolInfo fields represent an icon. StateValues, StateValue@Name, and StateValue@Value fields represent state variables. Here, the state variables indicate variables representing the state generated by the user's action on the web page, such as a user ID and a password.

Referring to FIG. 3, the digital television 23 includes an import unit 231, a user context information parsing unit 232, a user context information database (DB) 233, and a web browser 234.

The import unit 231 imports the URL and the user context information of the web page for the digital television 23 from the personal computer 22 for displaying the web page. In particular, the export unit 222 of the personal computer 22 and the import unit 231 of the digital television 23 recognize the mutual location based on a transmission control protocol/Internet protocol (TCP/IP).

The user context information parsing unit 232 parses the user context information imported by the import unit 231. The user context information has the format shown in FIG. 6. Accordingly, the user context information parsing unit 232 parses the user context information imported by the import unit 231 based on the format shown in FIG. 6 and obtains the user context information which can be recognized by the web browser 234.

FIG. 7 illustrates the user context information according to an exemplary embodiment of the present invention. An extensible markup language (XML) document shown in FIG. 7 is written using an XML based on the parsing result of the user context information parsing unit 232 and is then provided to the web browser 234.

The user context information database 233 stores the user context information parsed by the user context information parsing unit 232. Specifically, the user context information database 233 stores the URL and the user context information of the web page. For example, the user context information database 233 may store the URL and the user context information of the web page as a cookie.

The web browser 234 displays the web page based on the user context information imported by the import unit 231. In particular, the web browser 234 displays a list of at least one web page including the web page corresponding to the user context information stored in the user context information database 233, in addition to the user context information parsed by the user context parsing unit 232. If user context information previously imported by the import unit 231 as well as the user context information currently imported by the import unit 231 are stored in the user context information database 233, the web browser 234 displays the list of at least one web page including the user context information previously imported.

The user views the list of at least one web page and selects any one web page from the list of at least one web page through the web browser 234. When the web page is selected, the web browser 234 requests the web server 21 having the URL of the web page stored in the user context information database 233 to provide the web service of the user context information stored in the user context information database 233. In addition, the web browser 234 receives the web service of the user context information stored in the user context information database 233 from the web server 21 as a response of the request for the web service and displays the web page using the web service.

FIG. 8 illustrates a universal plug and play (UPnP)-based home network environment according to an exemplary embodiment of the present invention.

Referring to FIG. 8, the UPnP-based home network environment according to the present exemplary embodiment includes a web server 81, a personal computer 82, a media server 83, and a digital television 84.

When a user wants to receive a web service from the web server 81 using the personal computer 82, the user inputs the URLof a web page providing the web service of the web server 81 and a user ID and a password on the web page, using input units such as a keyboard and a mouse of the personal computer 82 to generate user context information. In other words, the user context information represents context generated by the user's action on the web page and each web page has its user context information.

According to the present exemplary embodiment, the user exports the user context information stored in the personal computer 82 to the media server 83 through a simple key operation and the digital television 84 imports the user context information from the media server 83. Thus, in order to receive the web service from the web server 81 using the digital television 84, the user need not input the URL and the user context information of the web page using a simple input unit such as a remote controller.

FIG. 9 illustrates configurations of the personal computer (PC) 82, the media server 83, and the digital television (DTV) 84 according to an exemplary embodiment of the present invention.

Referring to FIG. 9, the personal computer 82 according to the present exemplary embodiment includes a web browser 821, an export unit 822, a user context information generating unit 823, and a UPnP CP stack 824.

The web browser 821 displays a web page and receives a request for exporting the user context information of the web page through a user interface of the web page. In particular, the web browser 821 displays on the web page a link representing the export unit 822 installed in the web page in a plug-in form, and receives the request for exporting the user context information of the web page when the user clicks the link.

In addition, when the link representing the export unit 822 is clicked, the web browser 821 recognizes and executes the export unit 822 to process the request. In other words, the web browser 821 receives the request for exporting user context information of the web page through the user interface of the web page, and the web browser 821 displays a list of at least one media server searched by the UPnP CP stack 824.

Furthermore, the web browser 821 receives the request for exporting user context information of the web page to any one media server through the user interface of the web page. In other words, the user selects any one media server from the list of at least one media server displayed on the web page through the web browser 821.

When the user context information is exported to the UPnP CP stack 824, the web browser 821 displays a message on the web page that the user context information of the web page is exported.

When the export unit 822 receives the request for exporting the user context information of the web page through the web browser 821, the export unit 822 requests the UPnP CP stack 824 to search for the media server. Furthermore, when any one media server, for example, the media server 83, is selected through the web browser 821, the export unit 822 requests the UPnP CP stack 824 to export the user context information generated by the user context information generating unit 823 to the media server 83. Since the UPnP CP stack 824 searches for and exports the media server based on UPnP, the export unit 822 delivers the request from the web browser 821 to the UPnP CP stack 824, unlike the export unit 222.

The user context information generating unit 823 extracts information generated by the user's action on the web page from the web page displayed by the web browser 821 and generates the user context information in a predefined format to be recognized by the device according to the present exemplary embodiment.

When the UPnP CP stack 824 receives the request for searching for the media server from the export unit 822, the UPnP CP stack 824 searches for the media server for providing a content directory service based on UPnP to a device which can display the web page displayed by the web browser 821 in the home network having the personal computer 82 and outputs the searched results to the web browser 821.

Moreover, when the UPnP CP stack 824 receives the request for searching for the media server from the export unit 822, the UPnP CP stack 824 converts the user context information generated by the user context information generating unit 823 into a digital item declaration (DIDL) lite character string and calls a CreateObject action for the content directory service of the media server 83 based on the DIDL lite character string such that the URL and the user context information of the web page for a device for receiving the content directory service from the media server 83, such as the digital television 84, are exported to the media server 83.

FIGS. 10 and 11 illustrate the DIDL lite character string according to an exemplary embodiment of the present invention. The DIDL lite character string shown in FIG. 10 is obtained by defining the user context information in the DIDL lite in a new type to convert the user context information into the DIDL lite character string. The DIDL lite character string shown in FIG. 11 is obtained by defining the user context information in the DIDL lite in a desc element of the DIDL lite to convert the user context information into the DIDL lite character string.

Referring to FIG. 9, the media server 83 according to the present exemplary embodiment includes a UPnP controlled device (CD) stack 831 and a content directory service (CDS) module 832.

When the personal computer 82 calls the CreateObject action of the content directory service of the CDS module 832, the UPnP CD stack 831 stores the URL and the user context information of the web page in the DIDL lite character string form. The CDS module 832 supports a content directory service function based on UPnP.

Referring to FIG. 9, the digital television 84 according to the present exemplary embodiment includes a web browser 841, an import unit 842, and a UPnP CP stack 843.

The web browser 841 displays the web page and receives a request for displaying a list including at least one media server having the user context information through the user interface of the web page to display the list of at least one media server. Furthermore, the user selects any one media server from the list including at least one media server displayed on the web page through the web browser 841.

Furthermore, the web browser 841 displays a list of at least one web page including the web page corresponding to the user context information imported by the UPnP CP stack 843. The user clicks any one web page in the list of at least one web page through the web browser 841. In addition, when any one web page is selected, the web browser 841 requests the web server 81 to provide a web service of the user context information imported by the UPnP CP stack 843. Moreover, the web browser 841 receives the web service of the user context information imported by the UPnP CP stack 843 from the web server 81 as a response of the request for the web service and displays the web page using the web service.

When the request for displaying the list of media servers is received through the web browser 841, the export unit 822 requests the UPnP CP stack 824 to search for the media server. In addition, when the media server 83 for providing the content directory service based on UPnP to any one media server, for example, the digital television 84, is selected through the web browser 841, the import unit 842 requests the UPnP CP stack 843 to import the user context information from the media server 83. Since the UPnP CP stack 843 performs an import function based on UPnP, the import unit 842 delivers the request from the web browser 841 to the UPnP CP stack 843, unlike the import unit 231.

When the request for searching for the media server is received from the import unit 842, the UPnP CP stack 843 searches for the media server for providing the content directory service based on UPnP to the device which can display the web page displayed by the web browser 821 as a control point based on UPnP in a home network having the digital television 84 and outputs the searched result to the web browser 841.

Moreover, when the request for importing the user context information from the media server 83 is received from the import unit 842, the UPnP CP stack 824 calls a browse action and a search action of the content directory service of the media server 83 based on the user context information and imports the URL and the user context information of the web page for the digital television 84 from the media server 83.

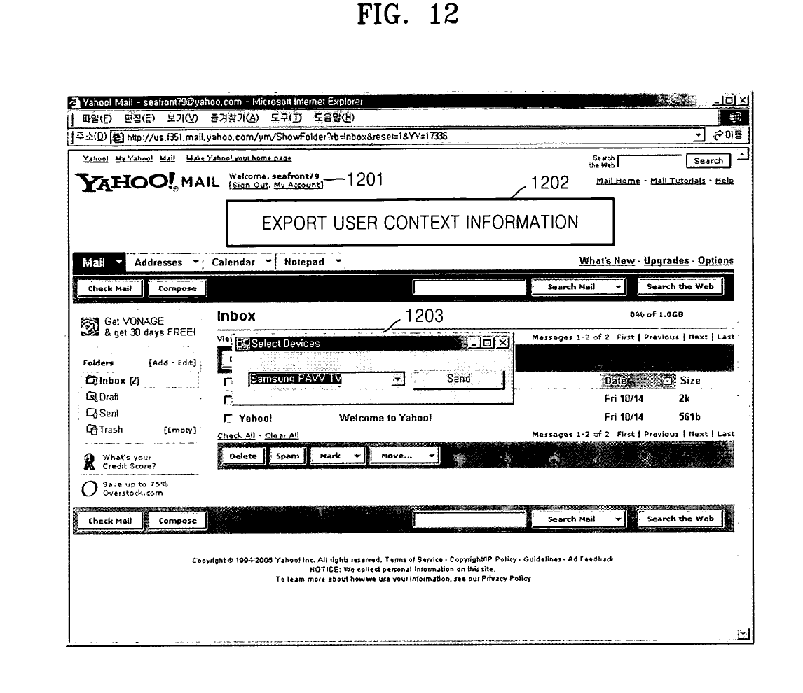

FIG. 12 illustrates a web page displayed on the personal computer 22 or 82 according to an exemplary embodiment of the present invention. Reference numeral 1201 indicates that the user login is completed, and thus the user context information of the web page is generated. In addition, reference numeral 1202 indicates a link for exporting the user context information of the web page. Moreover, reference numeral 1203 indicates a list of devices which are output by clicking the link 1202.

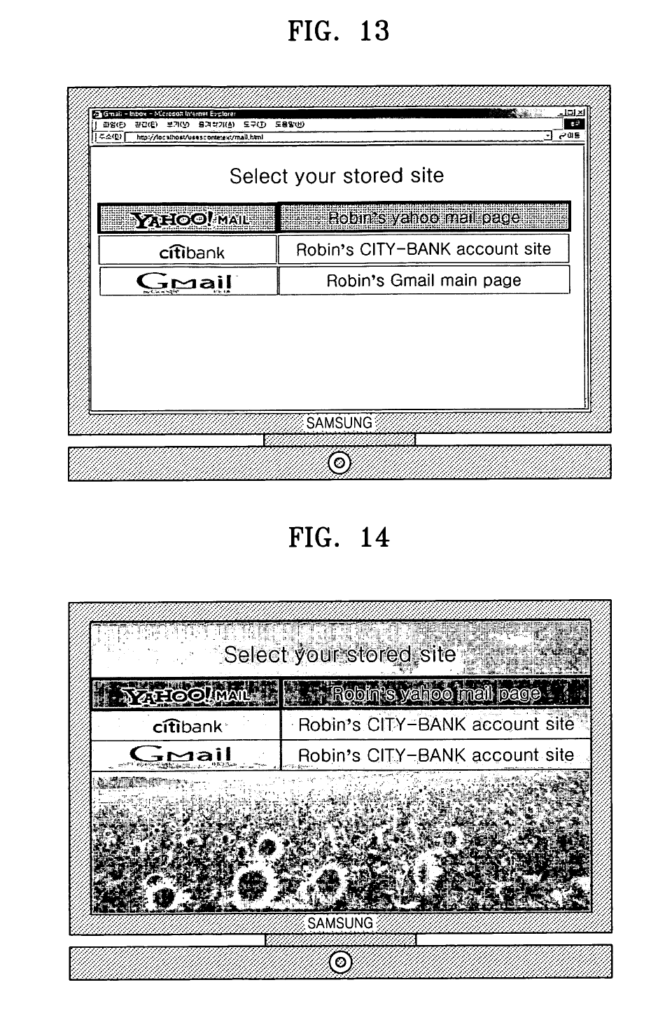

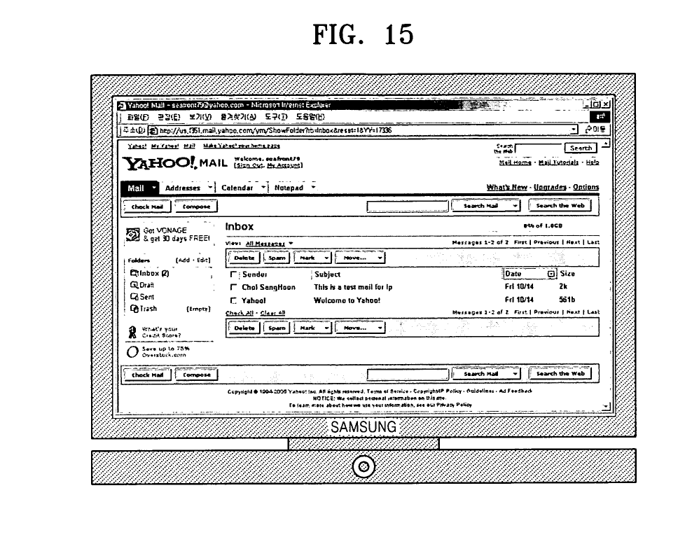

FIGS. 13 to 15 illustrate web pages displayed on the digital television 23 or 84 according to an exemplary embodiment of the present invention. FIG. 13 illustrates the existing web page and FIG. 14 illustrates a new web page. The user may select any one web page from a list of web pages shown in FIGS. 13 and 14 through a simple input operation using a remote controller. FIG. 15 illustrates a web page displayed on the digital television 23 or 84 based on the user context information previously stored when any one web page is selected.

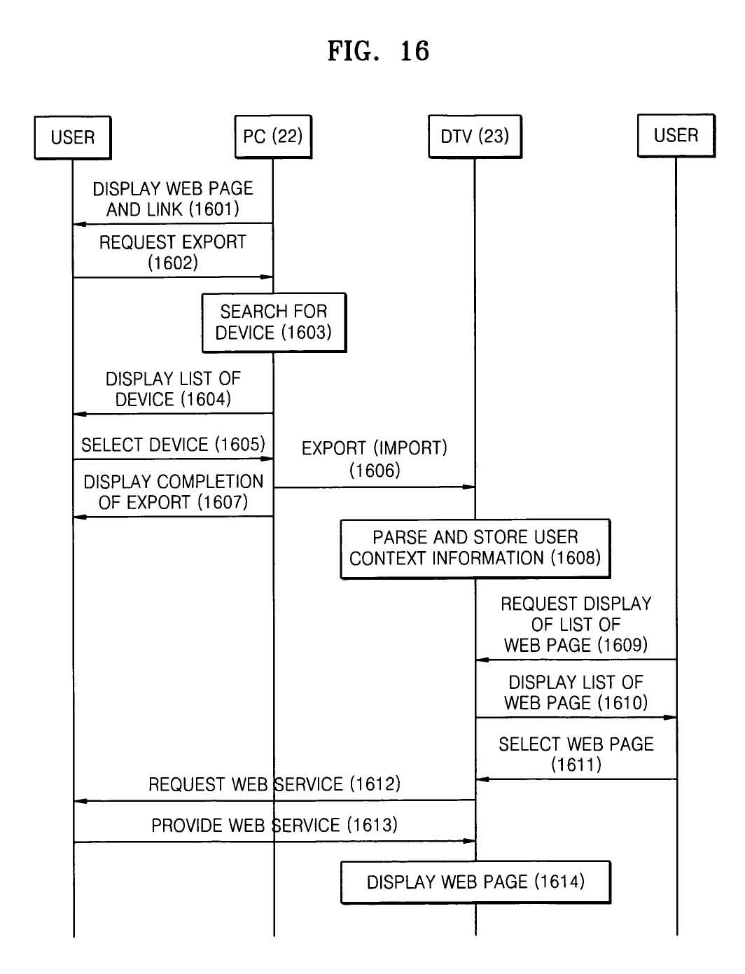

FIG. 16 is a flowchart illustrating a process of transmitting/receiving user context information according to an exemplary embodiment of the present invention.

Referring to FIG. 16, the process of transmitting/receiving the user context information according to the present exemplary embodiment includes a method of providing the user context information and a method of displaying a web page. The method of providing the user context information according to the present exemplary embodiment includes operations sequentially processed in the personal computer 22 shown in FIG. 3. Accordingly, the above description of the personal computer 22 shown in FIG. 3 will not be repeated. The method of displaying the web page according to the present exemplary embodiment includes operations sequentially processed in the digital television 23 shown in FIG. 3. Accordingly, the above description of the digital television 23 shown in FIG. 3 will not be repeated.

In operation 1601, the personal computer 22 displays the web page and a link representing the export unit 222 installed in the plug-in form in the web page.

In operation 1602, the user clicks the link displayed in operation 1601 to transmit a request for exporting the user context information of the web page displayed in operation 1601.

In operation 1603, when the request for exporting the user context information of the web page is received, the personal computer 22 searches for the devices which can display the web page displayed in operation 1601 in the home network having the personal computer 22.

In operation 1604, the personal computer 22 displays the list of devices searched in operation 1603 on the web page displayed in operation 1601.

In operation 1605, the user selects any one device from the list of devices displayed in operation 1604.

In operation 1606, when any one device, for example, the digital television 23, is selected in operation 1605, the personal computer 22 exports the URL and the user context information of the web page displayed in operation 1601 to the digital television 23. The digital television 23 imports the URL and the user context information of the web page for the digital television 23 from the personal computer 22 for displaying the web page.

In operation 1607, the personal computer 22 displays on the web page that the user context information is exported in operation 1606.

In operation 1608, the digital television 23 parses and stores the user context information imported in operation 1606.

In operation 1609, the user requests to display the list of at least one web page including the web page corresponding to the user context information stored in operation 1608.

In operation 1610, when the request for displaying the list of at least one web page is received in operation 1609, the digital television 23 displays the list including at least one web page including the web page corresponding to the user context information stored in operation 1608. If the user context information which is previously stored before operation 1608 exists, the digital television 23 displays the list of web pages including the user context information previously stored.

In operation 1611, the user views the list of at least one web page and selects any one web page from the list of at least one web page through the digital television 23.

In operation 1612, when any one web page is selected in operation 1611, the digital television 23 requests the web server 21 having the URL of the web page to provide a web service of the user context information stored in operation 1608.

In operation 1613, the digital television 23 receives the web service of the user context information stored in operation 1608 from the web server 21 in response to the request for the web service in operation 1612.

In operation 1614, the digital television 23 displays the web page using the web service received in operation 1613.

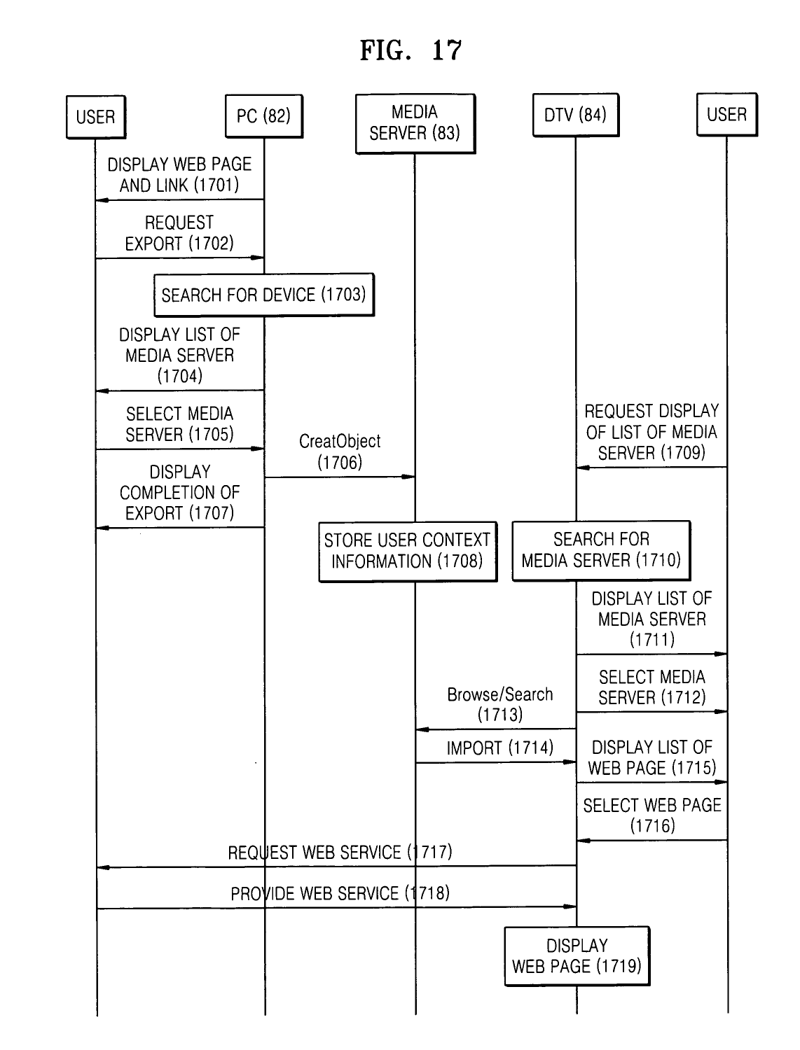

FIG. 17 is a flowchart illustrating a process of transmitting/receiving user context information based on UPnP according to an exemplary embodiment of the present invention.

Referring to FIG. 17, the process of transmitting/receiving the user context information based on UPnP according to the present exemplary embodiment includes a method of providing the user context information based on UPnP and a method of displaying a web page based on UPnP. The method of providing the user context information based on UPnP according to the present exemplary embodiment includes operations sequentially processed in the personal computer 82 shown in FIG. 9. Accordingly, the above description of the personal computer 82 shown in FIG. 9 will not be repeated. The method of displaying the web page based on UPnP according to the present exemplary embodiment includes operations sequentially processed in the digital television 84 shown in FIG. 9. Accordingly, the above description of the digital television 84 shown in FIG. 9 will not be repeated.

In operation 1701, the personal computer 82 displays the web page and a link representing the export unit 822 provided in the plug-in form in the web page.

In operation 1702, the user clicks the link displayed in operation 1701 to transmit a request for exporting the user context information of the web page displayed in operation 1701.

In operation 1703, when the request for exporting the user context information of the web page is received, the personal computer 82 searches for media servers 83 which can display the web page displayed in operation 1701 in the home network having the personal computer 82.

In operation 1704, the personal computer 82 displays the list of media servers searched in operation 1703 on the web page displayed in operation 1701.

In operation 1705, the user selects any one media server from the list of media servers displayed in operation 1704.

In operation 1706, when any one media server, for example, the media server 83, is selected, the personal computer 82 converts the URL and the user context information of the web page displayed into a DIDL lite character string and calls a CreateObject action of a content directory service of the media server 83 based on the DIDL lite character string to export the URL and the user context information of the web page to the media server 83.

In operation 1707, the personal computer 82 displays on the web page that the user context information is exported in operation 1706.

In operation 1708, the media server 83 stores the URL and the user context information of the web page in the DIDL lite character string form according to the call of the CreateObject action in operation 1706.

In operation 1709, the user requests to display a list of at least one media server including the media server which stores the user context information in operation 1708.

In operation 1710, when the request for displaying the list of at least one media server is received in operation 1709, the digital television 84 searches for the media server in the home network having the digital television 84.

In operation 1711, the digital television 84 displays a list of at least one media server searched in operation 1710.

In operation 1712, the user views the list of at least one media server and selects any one web page, for example, the media server 83, from the list of at least one media server through the digital television 84.

In operation 1713, when the media server 83 is selected in operation 1712, the digital television 84 calls a browse action and a search action of a content directory service of the media server 83 based on the user context information.

In operation 1714, the digital television 84 imports the URL and the user context information of the web page for the digital television 84 as the return of the browse action and the search action in operation 1713.

In operation 1715, the digital television 84 displays a list of at least one web page including the web page corresponding to the user context information imported in operation 1714.

In operation 1716, the user views the list of at least one web page displayed in operation 1715 and selects any one web page from the list of at least one web page through the digital television 84.

In operation 1717, when any one web page is selected in operation 1716, the digital television 84 requests the web server 81 having the URL of the web page to provide a web service of the user context information imported in operation 1714.

In operation 1718, the digital television 84 receives the web service of the user context information imported in operation 1714 from the web server 21 in response to the request for the web service in operation 1717.

In operation 1719, the digital television 84 displays the web page using the web service received in operation 1718.

The exemplary embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

According to the exemplary embodiments of the present invention, a user can export user context information stored in a personal computer to a CE device such as a digital television through a simple key operation such that the user context information can be automatically input to the CE device. As a result, a user need not input the URL and the user context information of a web page using a simple input unit such as a remote controller.

In addition, according to the present invention, a user can export user context information stored in a personal computer to a CE device such as a digital television through a simple key operation and the CE device can import the user context information from a media server such that the user context information can be automatically input to the CE device located on a UPnP network. As a result, even in a UPnP network environment, the URL and the user context information of a web page need not be input using a simple input unit such as a remote controller.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of providing user context information, the method comprising:
receiving a request to export user context information of a web page through a user interface of the web page; and
exporting the user context information to a device capable of displaying the web page according to the received request.

2. The method of claim 1, wherein the user context information represents context generated by a user's action on the web page, and,
the exporting comprises exporting a uniform resource locator (URL) and the user context information of the web page to the device.

3. The method of claim 1, wherein the receiving comprises receiving the request for exporting the user context information by clicking a link installed in a plug-in form in the web page.

4. The method of claim 1, further comprising, in response to the receiving the request for exporting the user context information, displaying a list of at least one device capable of displaying the web page such that any one device can be selected from the list of at least one device.

5. An apparatus for providing user context information, the apparatus comprising:
a web browser which receives a request to export user context information of a web page through a user interface of the web page; and
an export unit which exports the user context information to a device capable of displaying the web page according to the received request.

6. A computer-readable medium having embodied thereon a computer program for performing a method of providing user context information, the method comprising:
receiving a request to export user context information of a web page through a user interface of the web page; and
exporting the user context information to a device capable of displaying the web page according to the received request.

7. A method of displaying a web page, the method comprising:
importing user context information of the web page from a device; and
displaying the web page based on the imported user context information.

8. The method of claim 7, wherein the user context information represents context generated by a user's action on the web page, and,
the importing comprises importing a uniform resource locator (URL) and the user context information of the web page from the device.

9. The method of claim 7, wherein, in the displaying, if the web page is selected from a list of at least one web page including the web page, a web server having a uniform resource locator (URL) of the web page is requested to provide a web service of the user context information and the web page is displayed using the web service as a response of the request.

10. An apparatus for displaying a web page, the apparatus comprising:
an import unit which imports user context information of the web page from a device; and
a web browser which displays the web page based on the user context information imported by the import unit.

11. A computer-readable medium having embodied thereon a computer program for performing a method of displaying a web page, the method comprising:
importing user context information of the web page from a device; and
displaying the web page based on the imported user context information.

12. A method of providing user context information based on Universal Plug and Play (UPnP), the method comprising:
receiving a request to export user context information of a web page through a user interface of the web page; and
exporting the user context information to a media server which provides a content directory service based on UPnP to a device capable of displaying the web page, according to the received request.

13. The method of claim 12, wherein the user context information represents context generated by a user's action on the web page, and,
the exporting comprises exporting a uniform resource locator (URL) and the user context information of the web page to the media server.

14. The method of claim 12, wherein, in the receiving, the request for exporting the user context information is received by clicking a link installed in a plug-in form in the web page.

15. The method of claim 12, further comprising, in response to the receiving the request for exporting the user context information, displaying a list including at least one media server which provides a content directory service based on UPnP to a device capable of displaying the web page is displayed such that any one media server can be selected from the list of at least one media server.

16. The method of claim 12, wherein, in the displaying, the user context information is converted into a digital item declaration lite character string and a CreateObject action of the content directory service is called.

17. An apparatus for providing user context information, the apparatus comprising:
a web browser which receives a request to export user context information of a web page through a user interface of the web page; and
a Universal Plug and Play (UPnP) control point (CP) stack which exports the user context information to a media server which provides a content directory service based on UPnP to a device capable of displaying the web page, according to the received request.

18. A computer-readable medium having embodied thereon a computer program for performing a method of providing user context information based on Universal Plug and Play (UpnP), the method comprising:
receiving a request to export user context information of a web page through a user interface of the web page; and
exporting the user context information to a media server which provides a content directory service based on UPnP to a device capable of displaying the web page, according to the received request.

19. A method of displaying a web page based on Universal Plug and Play (UpnP), the method comprising:
importing user context information of the web page from a media server which provides a content directory service based on UPnP to a device capable of displaying the web page; and
displaying the web page based on the imported user context information.

20. The method of claim 19, wherein the user context information represents context generated by a user's action on the web page, and,
the importing comprises importing a uniform resource locator (URL) and the user context information of the web page from the media server.

21. The method of claim 19, wherein, in the importing, when the web page is selected from a list of at least one web page including the web page, the web server having a uniform resource locator (URL) of the web page is requested to provide a web service of the user context information, and the web page is displayed using the web service as a response of the request.

22. The method of claim 19, wherein, in the importing, a browse action and a search action of the content directory service are called, and a uniform resource locator (URL) and the user context information are imported from the media server as return of the call.

23. An apparatus for displaying a web page based on Universal Plug and Play (UpnP), the apparatus comprising:
a UPnP control point (CP) stack which imports user context information of the web page from a media server which provides a content directory service based on UPnP to a device capable of displaying the web page; and
a web browser which displays the web page based on the user context information imported by the UPnP CP stack.

24. A computer-readable medium having embodied thereon a computer program for performing a method of displaying a web page based on universal plug and play (UpnP), the method comprising:
importing user context information of the web page from a media server which provides a content directory service based on UPnP to a device capable of displaying the web page; and
displaying the web page based on the imported user context information.
